(19) United States
(12) Patent Application Publication
(10) Pub. No.: US 2006/0050684 A1
(43) Pub. Date: Mar. 9, 2006

(54) Message analysis systems and methods

(75) Inventors: Michael Bangham, Ellicott City, MD (US); Jake Funderburk, Murfreesboro, TN (US); Rob Garbarino, Bethpage, NY (US); Alan Scott, Riverhead, NY (US); Manju Shashibhushana, Dix Hills, NY (US); Brian Carman, Levittown, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/109,481

(22) Filed: Apr. 18, 2005

Related U.S. Application Data
(63) Continuation-in-part of application No. 10/935,806, filed on Sep. 7, 2004.

(51) Int. Cl. H04L 12/66

(52) U.S. Cl. 370/352; 370/513

(57) ABSTRACT

Systems and methods are disclosed for analyzing binary messages. In one embodiment, the method comprises receiving a binary message at a message analyzer system, obtaining one or more rules for the binary message, and analyzing the binary message with the message analyzer system to determine if the rules are satisfied.

### CROSS-REFERENCES TO RELATED APPLICATIONS

This application is a continuation-in-part of application Ser. No. 10/935,806, entitled “Methods and Systems for Analyzing Electronic Payment Transaction Data for Errors”, filed Sep. 7, 2004, the details of which are hereby incorporated by reference.

### BACKGROUND OF THE INVENTION

A number of different types of transactions may take place at point-of-sale devices. To process transactions, a point-of-sale device may transmit messages to a transaction gateway. For instances, point-of-sale devices may transmit authorization messages (e.g., credit card or debit card authorization messages), check validation messages, or stored value transaction request messages. The transaction gateway may then route the messages to the appropriate transaction service to process the message.

In order for a transaction gateway and/or transaction service to process messages without errors, point-of-sale devices must transmit messages in a specified format with predefined fields and/or field values. Thus, point-of-sale devices need to be configured to properly interact with a transaction gateway and/or transaction services to which a merchant subscribes. Merchants associated with point-of-sale devices may not know that its point-of-sale devices are not transmitting messages in the proper format or do not include the correct information until a transaction error occurs. This can lead to an embarrassing situation for the merchant as the transaction error may occur while a customer is at the point-of-sale device. In other cases, errors associated with transaction messages may not be immediately detected, but may still cause problems with customer transactions.

Typically, messages transmitted by point-of-sale devices are binary messages. Although binary messages are processed faster by computer systems, errors associated with binary messages are generally difficult to resolve. If a transaction error occurs, support personnel must manually attempt to recreate the error situation. Even if the binary message causing the error is saved, support personnel must still manually examine the binary message to determine what caused the error. This is also true in other environments in which binary messages are transmitted

### BRIEF SUMMARY OF THE INVENTION

Methods, systems, and machine-readable mediums are disclosed for analyzing messages. In some embodiments, the method comprises receiving a binary message at a message analyzer system. By way of example, the binary message may comprise a binary message associated with a point-of-sale transaction (e.g., credit card authorization request, check validation request, stored value transaction request, debit transaction authorization request, etc.). One or more rules are obtained for the binary message. The binary message is then analyzed with the message analyzer system to determine if the rules are satisfied.

In some aspects, the method may further comprise determining a message type of the binary message and retrieving the rules may comprise retrieving rules associated with the message type. A variety of techniques may be used to determine the message type. Merely by way of example, determining the message type may comprise for one or more message classification types, determining if a portion of the binary message is equal to a predetermined value associated with the message classification type.

Further aspects of the method may include obtaining message definition information (e.g., an XML file or other suitable data structure) and parsing the binary message into one or more fields using the message definition information. The analysis of the binary message may include determining, for at least one of the fields, if a value of the filed satisfies at least one of the rules associated with the field. In some instances, parsing the binary message may comprise parsing the binary message into a plurality of fields at a first hierarchical level. At least one of the fields at the first hierarchical level may then be parsed into a plurality of subfields. In other aspects, the method may further comprise generating a report including at least one result of the analysis. The report may be transmitted to an entity associated with an originator of the binary message.

In other embodiments, a method is disclosed which comprises receiving a binary message at a transaction gateway. The binary message is associated with a point-of-sale transaction. The binary message is routed to a message analyzer and the message analyzer analyzes the message to determine if one or more rules for the binary message are satisfied. An analysis report is then created including at least one result of the analysis.

Some aspects of the method may further comprise receiving credit card information at a point-of-sale device. The credit card information is associated with a test credit card used to validate authorization messages. The binary message, comprising an authorization message for the test credit card, is transmitted from the point-of-sale device to the transaction gateway.

In still further embodiments, the method may comprise receiving a binary message at a message analyzer system and determining a message type of the binary message. Message definition information associated with the message type is obtained. The binary message is parsed into one or more message fields using the message definition information. The method also comprises obtaining one or more rules associated with the message type. For at least one of the message fields, a determination is made as to whether a value of the field satisfies at least one of the rules associated with the field. A report is generated including at least one result of the analysis.

Message analyzer systems are also disclosed. In some embodiments, the message analyzer system comprises a communications interface to receive a binary message and to transmit a message analysis report. The message analyzer system also includes rule information having one or more rules for the binary message and analyzer logic to analyze the binary message to determine if the rules are satisfied. Report creator logic is configured to create the message analysis report, which includes at least one result of the analysis.

In further aspects, the message analyzer system may also comprise classifier logic to determine a message type of the binary message. In these aspects, the one or more rules included in the data storage may be associated with the message type. Alternatively or additionally, the message analyzer system may further comprise message definition information and parser logic communicatively coupled with the message definition information. The parser logic is configured to parse the binary message into one or more fields using the message definition information.

### BRIEF DESCRIPTION OF THE DRAWINGS

Illustrative embodiments in accordance with the invention are illustrated in the drawings in which:

FIG. 1 illustrates an exemplary embodiment of a message analyzer system.

FIG. 2 is a block diagram of an exemplary system that may use a message analyzer system to analyze messages.

FIG. 3 is a block diagram of an exemplary computer system upon which components of a message analyzer system may be implemented.

FIG. 4 is a flow diagram illustrating an exemplary method that may be used to analyze messages.

FIG. 5 is a flow diagram illustrating an example use of a message analyzer system.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

In some embodiments, various components may be described as being communicatively coupled with other components. A communicative coupling is any coupling that allows communication between the components. This coupling may be by means of a bus, cable, network, wireless mechanism, program code call (e.g., modular or procedural call) or other mechanism that allows communication between the components. Thus, it should be appreciated that components which are communicatively coupled may reside on the same or different physical devices. It should also be appreciated that additional components may be interspersed between components which are communicatively coupled.

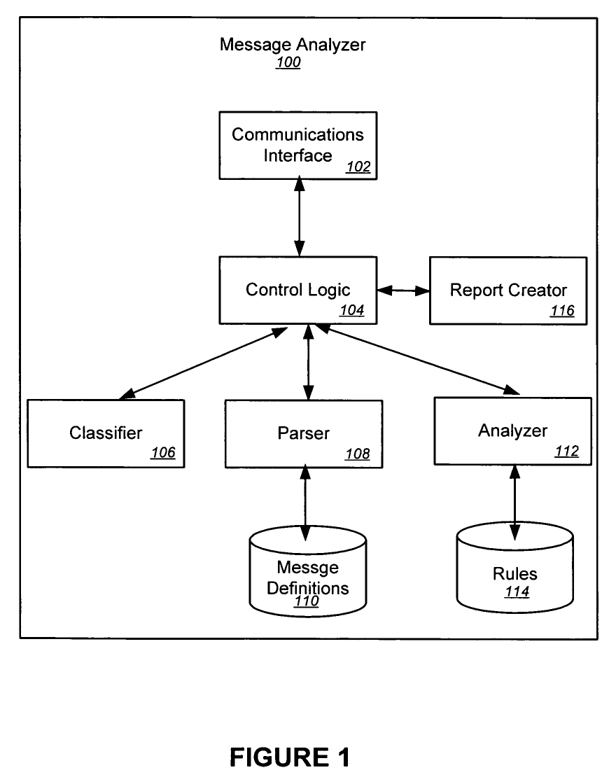

FIG. 1 illustrates an exemplary embodiment of a message analyzer system 100 that may be used to analyze binary messages. The message analyzer system 100 may include communications interface 102 communicatively coupled with control logic 104. Control logic 104 is also communicatively coupled with classifier logic 106, parser logic 108, analyzer logic 112 and report creator logic 116. The message analyzer system 100 may also include message definition information 110, communicatively coupled with parser logic 108, and rule information, communicatively coupled with analyzer logic 112.

Communications interface 102 may include one or more interfaces used by message analyzer system 100 to receive binary messages to be analyzed, to transmit analysis results, and/or to send and receive other types of communications to other systems. Merely by way of example, communications interface 202 may include an interface to a wide area network (WAN), such as the Internet or a proprietary WAN, and/or a local area network (LAN). Alternative or additional types of interfaces may also be included as components of communications interface 102.

Control logic 104, classifier logic 106, parser logic 108, analyzer logic 112, and report creator logic 116 may each be one or more software programs, one or more components of a software program (e.g., program module, program object, function, etc.), firmware, or other type of machine-executable instructions. As will be described below, each of the logic components 104, 106, 108, 112, 116 may perform one or more tasks related to the analysis of binary messages. It should be appreciated that in alternative embodiments, message analyzer system 100 may not include all of the logic components 104, 106, 108, 112, 116 described, may include additional logic components, and/or the logic components may be responsible for additional or fewer tasks than described.

Control logic 104 may be used to manage the binary message analysis process. To complete the analysis of a binary message, control logic 104 may route the binary message to other logic components 106, 108, 112, 116, which perform various tasks involved in the analysis of a message. In some aspects, a plurality of binary messages to be analyzed by message analyzer system 100 may be received on communications interface 102 in a batch file or other type of file, such as a trace file from a transaction gateway. In these aspects, control logic 104 may extract the binary messages to be analyzed. Additional functionality may also be performed by control logic 104 to manage and/or mediate between logic components used to analyze binary messages.

In some embodiments, message analyzer 100 may be used to analyze binary messages of multiple types. In these embodiments, classifier logic 106 may be used to determine the message type of a binary message. Merely by way of example, a binary message may be classified as a particular type of message by comparing a portion of the binary message (e.g., one or more bytes including a message type) to predetermined values associated with message classification types. Other tests may also be performed, such as tests to determine a message length or tests of other portions of the message.

In one aspect, classifier logic 106 may include a plurality of Boolean functions (e.g., java class files), each associated with a particular message type. The Boolean functions may each perform one or more tests on bytes of the binary message to determine if the message is the respective message type. The Boolean function may then transmit an output result indicating the message is of the function's particular message type (if the tests are satisfied) or the message does not satisfy the criteria to be classified as the particular message type. Other techniques may also be used by classifier 106 to determine a binary message's message type.

Parser logic 108 may be used to parse binary messages into one or more fields. Some fields in a binary message may be of fixed length, while other fields may be of variable length. The length of a variable length field may be specified within the binary message (e.g., as a first byte of a variable length field). Binary messages may, in some cases, include hierarchical fields, in which a field at a particular hierarchical level may include a plurality of subfields (fixed or variable) at a lower hierarchical level. A subfield, may in turn, also have its own subfields.

In some embodiments, parser logic 108 may obtain and use message definition information 110 to parse binary messages. Message definition information 110 may include information describing how to parse a binary message into its constituent fields. The message definition information 110 may be stored in any suitable data storage, such as Extended Markup Language (XML) file(s), database(s) (e.g., a relational or object database), spreadsheet(s), text file(s), internal software list(s), program object(s), or other suitable storage means. Message definition information 110 may, in some aspects, store a plurality of message definitions (e.g., XML files), each associated with different types of binary messages. It should be appreciated that in alternative embodiments, parser logic 108 may include program logic to determine how to parse a binary message and thus, message analyzer system 100 may not include message definition information 110 or message definition information 110 may be included in a different format than described.

Analyzer logic 112 may be used to analyze the binary message to determine if one or more rules 114 for the binary message are satisfied. Rule(s) 114 may be stored in XML file(s), databases(s), spreadsheet(s), text files(s), internal software list(s), program object(s), program logic, or other suitable means. In some aspects, rules may be associated with a particular message type and/or message fields. By way of example, an XML rule file may be included for each message type analyzed by message analyzer system 100. The XML rule file for a particular message type may include one or more rules for fields included in the message type. Other techniques may also be used to associate rules with message types and/or fields included in a message.

Rules 114 may specify whether a field is required, allowed value(s) of a field, data type of a field, prohibited fields, or any other appropriate rule for a binary message. Some rules 114 may vary or be applied differently depending upon the value of the field to which the rule is being applied or value of another field. For example, a rule may specify that a field is always required or that a field is only required if another field is included or another field has a specified value. It should be appreciated that binary messages may have a wide variety of different types of rules depending upon the particular use and type of the binary message.

Analyzer 112 may apply the rules 114 for a binary message to determine if the binary message satisfies the rules. An outcome of a rule analysis may indicate the rule is satisfied, the rule is not satisfied, or the rule could not be applied because of an error (e.g., a parsing error, error in another field, etc.). The output of analyzer 112 may be used by report creator 116 to create one or more reports indicating result(s) of the analysis of a binary message.

In some embodiments, report creator 116 may be a database report creator which creates a report based on information stored in a database. Thus, analyzer 112 may store analysis results in a database (not shown). The data may then be retrieved by report creator 116 and used to create reports. The reports may display information in any convenient manner (e.g., analysis result for each rule, analysis results for unsatisfied rules, etc.). Report creator 116 may also create reports indicating analysis results of multiple messages of the same or different message types. In other embodiments, report creator 116 may not be a database report creator.

It should be appreciated that message analyzer system 100 may be used in any number of ways. For example, message analyzer system 100 may be used by support personnel to analyze binary messages which caused processing errors. Message analyzer system 100 may also be used to test systems prior to deployment or to determine if systems initiating binary messages are properly configured.

In alternative embodiments, message analyzer system 100 may include additional, fewer, or different components than illustrated. Additionally, components described above may be configured differently than described to perform additional, fewer, or different tasks.

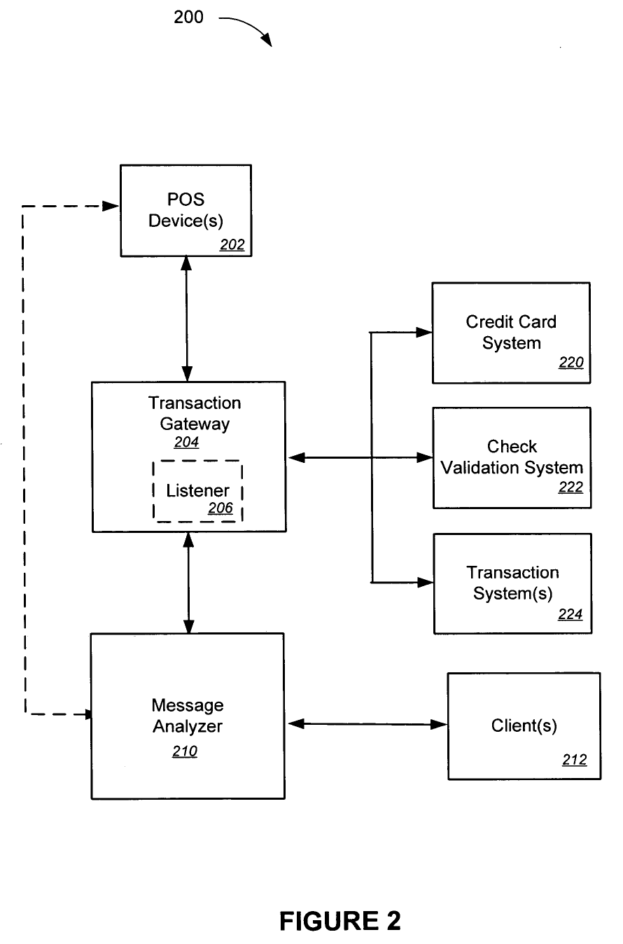

FIG. 2 illustrates an exemplary embodiment of a system 200 which uses a message analyzer system 210 to analyze binary messages associated with point-of-sale transactions. The system 200 includes one or more point-of-sale devices 202 communicatively coupled with transaction gateway 204. Transaction gateway 204 may be communicatively coupled with a plurality of transaction systems 220, 222, 224 and message analyzer system 210. Message analyzer system 210 may also be communicatively coupled with one or more client(s) 212 and/or point-of-sale device(s) 202.

Point-of-sale device(s) 202 may be used to perform merchant and/or customer functions related to transactions initiated by customers, such as a transaction for the purchase of goods or services or a money transfer transaction. For example, point-of-sale device(s) 202 may be used to receive payment (e.g., check, credit card, debit card, stored value card, or other payment type) for the transaction from the customer. As another example, point-of-sale device(s) 202 may be used by an agent to enter details of a money transfer transaction (e.g., recipient information, money transfer amount) using point-of-sale device. In some embodiments, point-of-sale device(s) 202 may also include one or more of the components to or functionality described in U.S. application Ser. No. 10/116,689, entitled “Systems and Methods for Performing Transactions at A Point-of-Sale”, filed Apr. 3, 2002, the details of which are hereby incorporated by reference.

Transaction details may be submitted to a transaction gateway 204 by point-of-sale device(s) 202 in messages transmitted to transaction gateway 204. Merely by way of example, messages transmitted from a point-of-sale device 202 to transaction gateway 204 may include authorization requests for credit or debit transactions, check validation requests, stored value transaction requests, money transfer requests, or any other type of request associated with a point-of-sale transaction. A messages may be a binary message which includes a request to perform a transaction service to process the transaction and transaction details.

Transaction gateway 204 may route the message to the appropriate transaction system 220, 222, 224 for processing. Merely by way of example, messages requesting authorization for a credit card transaction may be routed to a credit card transaction system 220. As another example, messages requesting validation of a check may be routed to check validation system 222. Other types of messages, such as messages requesting debit card authorization, stored value transaction request messages, money transfer messages, or any other type of transaction message may be transmitted to the appropriate transaction system 224. Thus, it should be appreciated that system 200 may include additional, fewer, or different transaction systems than illustrated in FIG. 2.

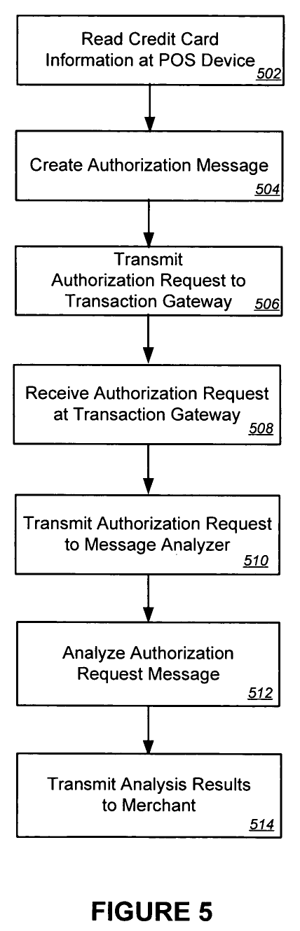

Messages associated with point-of-sale transactions may also be routed by transaction gateway 204 to message analyzer 210. In some embodiments, transaction gateway 204 may include logic to determine which messages to transmit to message analyzer 210. For instances, message analyzer 210 may include a listener 206 to monitor for certain types of messages (e.g., test messages, messages causing transaction errors, etc.). Alternatively, another logic mechanism may be used by transaction gateway 204 to select messages to be analyzed by message analyzer 210. Messages that may be selected for transmission may include test messages (which may be initiated as described below with reference to FIG. 5), messages associated with transaction errors, messages associated with designated merchants, and/or messages of a designated type. In alternative embodiments, transaction gateway 204 may transmit all of the messages received and/or transmitted to message analyzer 210, which may then determine which messages to analyze.

Transaction gateway 204 may transmit messages to message analyzer 210 on a real-time basis after the message has been received and/or determined to be a message to transmit to message analyzer 210. Alternatively, transaction gateway 204 may transmit messages in a batch job. In some aspects, listener 206 or other component of transaction gateway 204 may create a file (e.g., a trace file) with the messages to be analyzed by message analyzer 210. The file with the messages to be analyzed may then be transmitted at a predetermined time or upon request of the message analyzer 210. Alternative techniques may also be used to provide the point-of-sale transaction messages to message analyzer 210. For example, in some embodiments, point-of-sale devices 202 may transmit messages to message analyzer 210.

Message analyzer system 210 may be configured as described in any of the embodiments or variations described above. After a message has been analyzed, report(s) may be created by message analyzer 210 indicating result(s) of the message analysis. The message analysis report(s) may then be transmitted (asynchronously or upon request) from the message analyzer system to client(s) 212, point-of-sale devices, or other systems. Alternatively or additionally, transaction report(s) may be transmitted back to transaction gateway 204. Transaction gateway 204 may then transmit the report(s) to point-of-sale device(s) 202 or other designated recipient of the analysis reports. Thus, any authorized person or entity (e.g., merchant associated with point-of-sale device, support personnel associated with transaction gateway 204 and/or transaction systems 220, 222, 224, etc.) may use a client computer system 212 to obtain message analysis results.

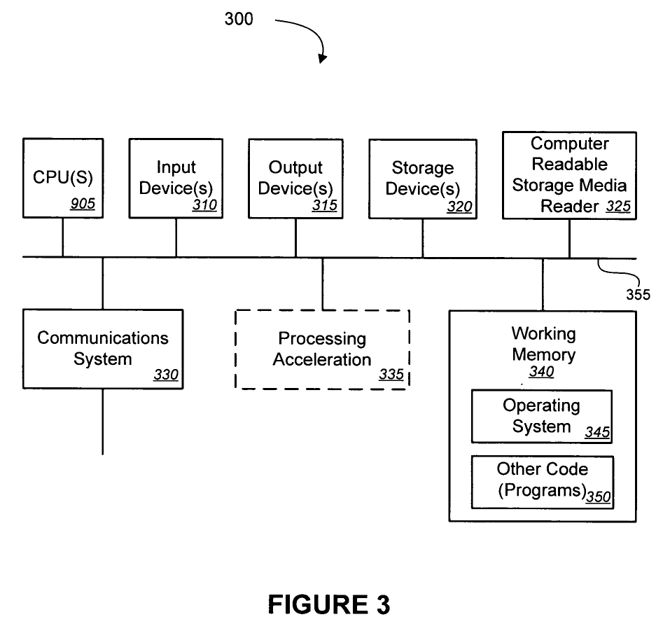

FIG. 3 illustrates one embodiment of a computer system 300 upon which components of a message analyzer system (e.g., classifier logic 106, analyzer logic 112, report creator logic 116) may be implemented. The computer system 300 is shown comprising hardware elements that may be electrically coupled via a bus 355. The hardware elements may include one or more central processing units (CPUs) 305; one or more input devices 310 (e.g., a scan device, a mouse, a keyboard, etc.); and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325; a communications system 330 (e.g., a modem, a network card (wireless or wired), an infra-red communication device, etc.); and working memory 340, which may include RAM and ROM devices as described above. In some embodiments, the computer system 300 may also include a processing acceleration unit 335, which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer or other type of device, such as a POS device.

The computer system 300 may also comprise software elements, shown as being currently located within a working memory 340, including an operating system 345 and/or other code 350, such as an application program. The application programs may implement a message analyzer system, components of a message analyzer system, and/or the methods of the invention. It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

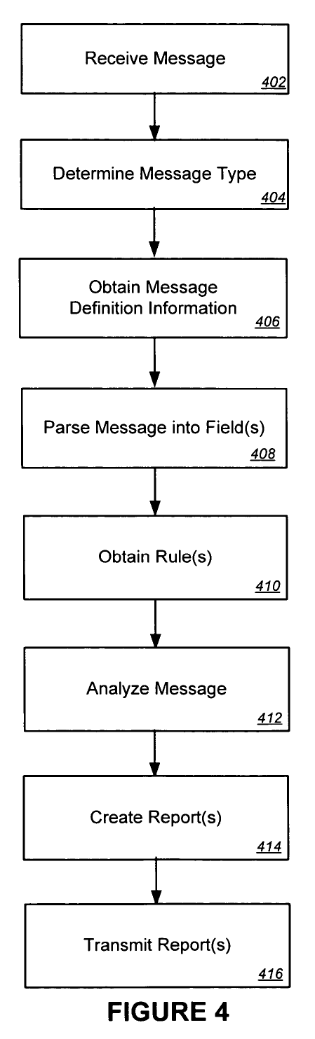

FIG. 4 is a flow diagram illustrating an exemplary method that may be used to analyze a binary message. The method may begin by receiving 402 a binary message to analyze. The binary message may be any type of message to be analyzed to determine if the message meets criteria for the particular message type. Merely by way of example, the binary message may be a message associated with a point-of-sale transaction (e.g., a credit or debit authorization request, a check validation request, a stored value transaction request, etc.).

The message type of the binary message may then be determined 404. In some embodiments, the message type may be determined by executing one or more Boolean functions to determine if the message is of the type associated with the Boolean function. Each of the functions may include one or more criteria tests associated with the message or portions of the message (e.g., message bytes) to determine if the message should be classified as a particular type. For instances, a classification test may include determining if values of one or more of the bytes equals a predefined value or falls within a range of values for the message classification type. Another classification test may determine if the length of message satisfies length criteria for the message type being tested. Other types of tests may also be performed. The message may be classified with the message type of the Boolean function which returns a result indicating the criteria for its classification type have been satisfied. It should be appreciated that a wide variety of other techniques may also be used to determine 404 the message type of the binary message.

Message definition information is obtained at block 406. The message definition information includes information on how to parse a binary message into its component fields. The message definition information may be associated with the determined message type. In some embodiments, the message definition information may be obtained 406 by retrieving an XML file including a description of the fields and positions of the fields included in a message type. In other embodiments, the message definition information may be obtained 404 from a database, a text file, an internal software structure, or other suitable location.

The message may then be parsed 408 into its component fields based on the information in the message definition information. The message definition information may specify that some of the fields are a fixed length. Other fields may be a variable length. When parsing 408 the message, the bytes to be included in a variable length field may be determined based on a value or values of designated byte(s), such as the first byte of the variable length field and/or a byte included in another field. Additionally, some of the fields of a binary message may have one or more subfields. Thus, the parser may parse some of the message into fields at a first hierarchical level. One or more fields at the first hierarchical level may be further parsed into its subfields. Subfields may also be further parsed into their own subfields.

At block 410, one or more rules for the binary message are obtained. The rules may be associated with the message type of the binary message. In some embodiments, rules for a binary message may be obtained 410 by obtaining an XML file associated with the message type of the binary message. The XML file may include one or more rules for the fields included in the message. In other embodiments, the rules may be obtained 410 from a database, a text file, a spreadsheet, internal software structure (lists, program objects, etc.), or other type of data structure.

The binary message may then be analyzed 412 to determine if the rules associated with the message are satisfied. For example, the analysis 412 may include determining if the message includes all of the required fields. The rules may specify some fields that are always required, while other fields may be conditionally required (e.g., if another field is present or not present, or if a value of a field is equal to a designated value). As another example, the analysis may include whether the value of a field is equal to an allowed value or falls within an allowed range of values. The message may also be analyzed 412 to determine if it includes any prohibited fields or values. The analysis may also alternatively or additionally include analyzing whether other types of rules associated with the binary message are satisfied.

At block 414, one or more reports are created 414. A report may include one or more results of the message analysis. For example, a report may be created 414 which includes information on each of the rules the binary message did not satisfy. Alternatively, a report may include a result for each of the rules for the message. Other types of reports may also be created 414. In some aspects, a report may be created which includes results for a plurality of messages which were analyzed.

The report(s) may then be transmitted 416 to any authorized entity or person Merely by way of example, the report may be transmitted to an entity or person associated with an originator of the binary message (e.g., a merchant associate with a point-of-sale device) or support personnel associated with a target destination of the binary message. Report(s) may be created 414 and/or transmitted 416 upon request. Alternatively, reports may be created 414 and/or transmitted 416 at schedule intervals and/or upon the occurrence of a specified event, such as a transaction failure associated with the binary message.

In other embodiments, the method may be performed differently than described above. For example, in some embodiments, the method may include determining 404 the message type. Other variations are also contemplated.

FIG. 5 is a flow diagram of an exemplary use of a message analyzer system. The message analyzer system may be used to analyze whether a point-of-sale device is configured to properly create credit card authorization messages. The method may begin by receiving credit card information at a point-of-sale device. The credit card information may be received 502 by using a magnetic card reader or other type of card reader device. In some aspects, the credit card may be a test credit card used to validate authorization messages transmitted from point-of-sale devices.

The point-of-sale device may then create 504 an authorization request message. The authorization request message may be a binary message which includes the credit card information and details of a transaction for which the credit card was presented (e.g., dollar amount of transaction, etc.). The point-of-sale device may then transmit 506 the authorization message to a transaction gateway.

After the authorization request message is received 508 at the transaction gateway, the transaction gateway may transmit 508 the authorization request message to a message analyzer. The authorization request message may be transmitted 508 to the message analyzer by routing the message to the message analyzer or by transmitting the message as part of a batch file or trace file. As previously described, the transaction gateway may have first determined the message should be transmitted to the message analyzer because of the occurrence of an event or satisfaction of other criteria. Merely by way of example, transaction gateway may transmit messages to message analyzer that are associated with “test” accounts, designated merchants, and/or designated point-of-sale devices; messages of designated transaction types; transaction type to be analyzed, message causing a transaction error, or messages meeting other criteria. Alternatively, transaction gateway may transmit all transaction messages to message analyzer and message analyzer may determine which messages to analyze.

At block 410, the message analyzer system may analyze the authorization request message, as described above. The results of the analysis may then be transmitted 512 to the merchant associated with the point-of-sale device. The merchant may then use the information to determine configuration changes (if any) that need to be made to the point-of-sale device to properly transmit authorization request messages.

It should be appreciated that message analyzer system may analyze different types of point-of-sale transaction messages than described above. Merely by way of example, message analyzer system may be used to analyze debit authorization messages, stored value transaction messages, money transfer messages, check validation messages, or other type of transaction message. These messages may also be test messages created for the purposes of analyzing the messages transmitted by a point-of-sale device (e.g., a message created with a test checking account number, a test stored value account number, etc.). It should also be appreciated that message analyzer system may also be used to analyze messages other than point-of-sale transaction messages.

In the foregoing description, for the purposes of illustration, methods were described in a particular order. In alternate embodiments, the methods may be performed in a different order than that described. Additionally, the methods may contain additional or fewer steps than described above. The methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving, at a message analyzer system, a binary message;
obtaining one or more rules for the binary message; and
analyzing the binary message with the message analyzer system to determine if the rules are satisfied.

2. The method of claim 1, further comprising:
determining a message type of the binary message; and
wherein retrieving the rules comprises retrieving one or more rules associated with the message type.

3. The method of claim 2, wherein determining the message type comprises
for one or more message classification types, determining if a portion of the binary message is equal to a predetermined value associated with the message classification type.

4. The method of claim 1, further comprising:
obtaining message definition information;
parsing, with the message analyzer system, the binary message into one or more fields using the message definition information; and
wherein analyzing the binary message comprises determining, for at least one of the fields, if a value of the field satisfies at least one of the rules associated with the field.

5. The method of claim 4, wherein parsing the binary message comprises:
parsing the binary message into a plurality of fields at a first hierarchical level; and
parsing at least one of the fields at the first hierarchical level into a plurality of subfields.

6. The method of claim 4, wherein the message definition information comprises an Extended Markup Language (XML) file.

7. The method of claim 1, further comprising generating a report including at least one result of the analysis.

8. The method of claim 7, further comprising transmitting the report to an entity associated with an originator of the binary message.

9. The method of claim 1, wherein the binary message comprises a binary message associated with a point-of-sale transaction.

10. The method of claim 9, wherein the binary message comprises a credit card authorization request.

11. The method of claim 9, wherein the binary message comprises a check validation request.

12. The method of claim 9, wherein the binary message comprises a stored value transaction request message.

13. The method of claim 9, wherein the binary message comprises a debit transaction authorization request message.

14. The method of claim 1, wherein retrieving the one or more rules comprises retrieving an Extended Markup Language (XML) file

15. A method comprising:
receiving, at a transaction gateway, a binary message associated with a point-of-sale transaction;
transmitting the binary message from the transaction gateway to a message analyzer;
analyzing the binary message with the message analyzer to determine if one or more rules for the binary message are satisfied; and
creating an analysis report including at least one result of the analysis.

16. The method of claim 15, further comprising transmitting the analysis report to a merchant associated with the point-of-sale transaction.

17. The method of claim 15, further comprising:
receiving, at the point-of-sale device, credit card information associated with a test credit card used to validate authorization messages; and
transmitting the binary message from the point-of-sale device to the transaction gateway, the binary message comprising an authorization message for the test credit card.

18. The method of claim 15, wherein the binary message comprises one of a check validation request, a stored value transaction request, and a debit transaction authorization request.

19. A method comprising:
receiving, at a message analyzer system, a binary message;
determining, at the message analyzer system, a message type of the binary message;
obtaining message definition information associated with the message type;
parsing, with the message analyzer system, the binary message into one or more message fields using the message definition information;
obtaining one or more rules, the rules associated with the message type and at least a subset of the rules each associated with a field included in the message type;
determining, for at least one of the message fields, if a value of the respective message field satisfies at least one of the rules associated with the field; and
generating a report including at least one result of the analysis.

20. The method of claim 19, wherein the binary message comprises a binary message associated with a point-of-sale transaction.

21. A message analyzer system comprising:
a communications interface, to receive a binary message and to transmit a message analysis report;
rule information having one or more rules for the binary message;
analyzer logic to analyze the binary message to determine if the rules are satisfied; and
report creator logic to create the message analysis report, the message analysis report including at least one result of the analysis.

22. The message analyzer system of claim 21, further comprising:
classifier logic to determine a message type of the binary message; and
wherein the one or more rules included in the data storage are associated with the message type.

23. The message analyzer system of claim 21, further comprising:
message definition information; and
parser logic, communicatively coupled with the message definition information, to parse the binary message into one or more fields using the message definition information.

24. A system comprising:
the message analyzer system of claim 21, wherein the binary message comprises a message associated with a point-of-sale transaction; and
a transaction gateway, communicatively coupled with the transaction gateway, to route the binary message to the message analyzer system.

25. The system of claim 24, further comprising a point-of-sale device, communicatively coupled with the transaction gateway, to transmit the binary message to the transaction gateway.

26. At least one machine-readable medium, having stored thereon sequences of instructions, which, when executed by a machine, cause the machine to perform the actions of:
receiving, at a message analyzer system, a binary message;
obtaining one or more rules for the binary message; and
analyzing the binary message with the message analyzer system to determine if the rules are satisfied.
